(19) United States
(12) Patent Application Publication
(10) Pub. No.: US 2007/0281725 A1
(43) Pub. Date: Dec. 6, 2007

(54) DEVICE AND METHOD FOR SILENT PUSH-TO-TALK CALL PACING

(76) Inventor: Edward C. Hyatt, Durham, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/420,869

(22) Filed: May 30, 2006

(51) Int. Cl. H04Q 7/20

(52) U.S. Cl. 455/519

(57) ABSTRACT

A portable communication device is equipped with silent push-to-talk (PTT) call pacing. The portable communication device includes a tactile alert generator, a controller for the tactile alert generator, and a PTT processor in operative communication with the controller for the tactile alert generator. The PTT processor encodes a received PTT call state prompt into a tactile signal, and generates a tactile signal that causes the tactile alert generator to generate a tactile alert indicative of the received PTT call state prompt

### TECHNICAL FIELD OF THE INVENTION

The present invention relates generally to portable communication devices, and, more particularly, to a portable communication device and method including silent push-to-talk (PTT) call pacing using vibration bursts.

### DESCRIPTION OF RELATED ART

Technology advancement has made portable communication devices, such as mobile telephones, personal digital assistants, mobile terminals and the like, more affordable for everyone. As portable communication devices are manufactured with greater processing ability and storage, they also become more versatile and incorporate many features, such as direct radio communication capability between two or more portable communication devices. This direct radio communication is commonly referred to as “walkie-talkie” or “push-to-talk” (PTT) communications. Walkie-talkie or push-to-talk (PTT) type communications services are becoming more widely available from communications service providers, as communication standards are being adapted to provide such functionality or services.

PTT communications allow a user to communicate with one or more parties or a group without dialing a destination phone number. In a PTT system, a portable communication device uses one frequency for both upward and downward communications with a remote server. In general, the PTT system requires a user to push and hold a button while talking, and then release the button to switch to a receive or listen mode. Any listener in the group can then press their button to respond.

Conventional PTT communications often are recognized by the (sometimes loud) audio signals that accompany PTT interactions. For example, PTT communications typically include a number of rather loud “DOOO-DEEP” audio signals that are used to indicate various call states, e.g., an incoming conversation request, the floor is open, a user having control of the floor and the like, during a PPT communications session. While this type audio-signal-driven call pacing provides structure to PTT communications, some users and bystanders may find these audio signals to be annoying or otherwise disruptive.

### SUMMARY

In view of the foregoing, a need exists for a portable communication device and an associated application program that provides silent push-to-talk (PTT) call pacing using vibration bursts to signal various call states during a PTT communication session.

One aspect of the invention relates to a method of pacing a push-to-talk (PTT) communication session that includes receiving a PTT call state prompt, encoding the received PTT call state prompt into a tactile signal and generating a tactile alert indicative of the received PTT call state prompt.

According to another aspect, the tactile alert includes one or more vibration bursts.

According to another aspect, generating one or more vibration bursts includes pulsing a vibration motor to cause no more than about one to about three revolutions of the vibration motor.

According to another aspect, encoding includes producing a set of tactile alerts comprised of vibration bursts that are distinguishable by (i) vibration intensity, (ii) vibration duration, and/or (iii) vibration duty cycle.

According to another aspect, encoding includes suppressing an audio signal associated with a PTT call state prompt, and replacing the suppressed audio signal with one or more vibration bursts.

According to another aspect, each distinguishable tactile alert is indicative of one or more PTT call state prompts.

According to another aspect, the PTT call state prompts include (i) incoming conversation request, (ii) indication that a PTT communication floor is open, (iii) granting of control of the PTT communication floor, (iv) denial of control of the PTT communication floor, (v) arrival or departure of a user to a PTT communication session, and/or (vi) termination of the PTT communication session.

Another aspect of the invention relates to a portable communication device that includes a tactile alert generator that generates tactile alerts, a controller for the tactile alert generator and a push-to-talk (PTT) processor in operative communication with the controller for the tactile alert generator. The PTT processor encodes a received PTT call state prompt into a tactile signal and generates a tactile signal that causes the tactile alert generator to generate a tactile alert indicative of the received PTT call state prompt.

According to another aspect, the tactile alerts include one or more vibration bursts.

According to another aspect, the PTT call state prompts include (i) incoming conversation request, (ii) indication that a PTT communication floor is open, (iii) granting of control of the PTT communication floor, (iv) denial of control of the PTT communication floor, (v) arrival or departure of a user to a PTT communication session, and/or (vi) termination of the PTT communication session.

According to another aspect, the tactile alert generator comprises a vibrator.

According to another aspect, the vibrator comprises an axially offset counterweight driven by a motor.

According to another aspect, the vibrator produces one or more vibration bursts.

According to another aspect, a vibration burst is produced by about one to about three motor revolutions of the counterweight.

According to another aspect, a vibration burst is produced by no more than about five motor revolutions of the counterweight.

According to another aspect, the vibrator comprises a piezoelectric vibration device.

According to another aspect, the portable communication device is a mobile telephone.

Another aspect of the invention relates to a program stored on a machine readable medium, the program being suitable for use in a portable communication device, wherein when the program is loaded in memory in the portable communication device and executed causes the portable communication device to encode a received PTT call state prompt into a tactile signal and generate a tactile signal that causes a tactile alert generator to generate a tactile alert indicative of the received PTT call state prompt.

According to another aspect, the program causes the tactile alert generator to generate one or more vibration bursts indicative of the received PTT call state prompt.

According to another aspect, a portable communication device includes a memory and a processor that executes an application program that causes the portable communication device to encode a received PTT call state prompt into a tactile signal and generate a tactile signal that causes a tactile alert generator to generate a tactile alert indicative of the received PTT call state prompt.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a diagrammatic illustration of a communication system that supports push-to-talk communications including a portable communication device on which aspects of the present invention are carried out;

FIG. 2 is a diagrammatic illustration of a portable communication device in accordance with an embodiment of the present invention;

FIG. 3 is a flow chart or diagram representing the relevant operation of a portable communication device in accordance with an embodiment of the present invention; and

FIG. 4 is an exemplary signal flow diagram representing the relevant operation of a portable communication device during a push-to-talk communication session in accordance with an embodiment of the present invention.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

Aspects of the invention include a portable communication device and method of silent call pacing during a PTT communication session.

As used herein, the term “portable communication device” includes portable radio communication equipment. The term “portable radio communication equipment”, which herein after may be referred to as a mobile phone, a mobile device, a mobile radio terminal or a mobile terminal, includes all electronic equipment, including, but not limited to, mobile telephones, pagers, communicators, i.e., electronic organizers, smartphones, personal digital assistants (PDAs), or the like. While the present invention is being discussed with respect to portable communication devices, it is to be appreciated that the invention is not intended to be limited to portable communication devices, and can be applied to any type of electronic equipment capable of being used in connection with push-to-talk (PTT) communications.

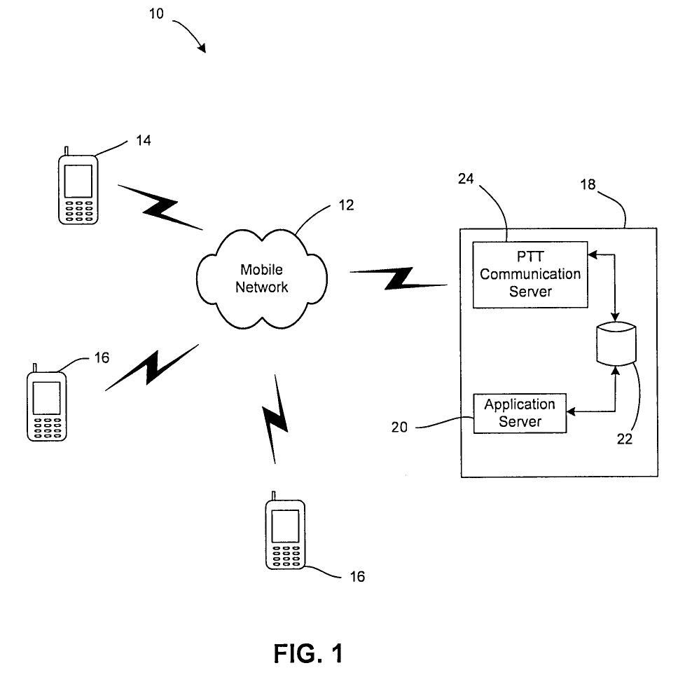

Referring initially to FIG. 1, a communication system 10 includes a mobile network 12, such as a mobile cellular telephony network, that facilitates communication, such as voice communication and/or data transfer between a plurality of portable communication devices 14 and 16, such as mobile phones, mobile terminals or the like. The communication system 10 and at least two of the portable communication devices 14, 16 support PTT communications, e.g., by including a PTT application program. For purposes of the discussion contained herein, portable communication device 14 will be described in terms of initiating or activating a PTT session with portable communication devices 16. However, it will be appreciated that the method described more fully below can be carried out by any suitably equipped portable communication device, regardless of whether that device initiates a PTT session or responds to an invitation to participate in a PTT session.

The communication system 10 includes a network infrastructure 18, portions of which are used or otherwise accessed by the portable communication devices in connection with aspects of the invention. The portable communication devices 14, 16 may interact with each other and/or the network infrastructure in accordance with any suitable communication standard, including, but not limited to, Advanced Mobile Phone Service (AMPS), Digital Advanced Mobile Phone Service (D-AMPS), General Packet Radio Service (GPRS), Universal Mobile Telecommunications System (UMTS), Global System for Mobile Communications (GSM), Code Division Multiple Access (CDMA), Voice-Over IP (VoIP), Session Initiated Protocol (SIP), Wireless Local Area Network (WLAN) or the like. In other words, the communication system is shown in FIG. 1 for purposes of explaining aspects of the present invention, without limiting the invention to a particular communication system design, architecture or communication standard.

The network infrastructure 18 includes one or more application servers, which are indicated generally by the numeral 20, and a storage device 22, such as a memory for storing data accessible or otherwise usable by the application servers 18. At least one of the application servers is a push-to-talk (PTT) communication server 24. The application servers 18, including the PTT communication server 24, are computer servers that serve different functions in the communication system. As is described more fully below, the portable communication devices 14 and 16 are operable to provide silent call pacing to indicate a number of call states or call state prompts that occur during a typical PTT communication session.

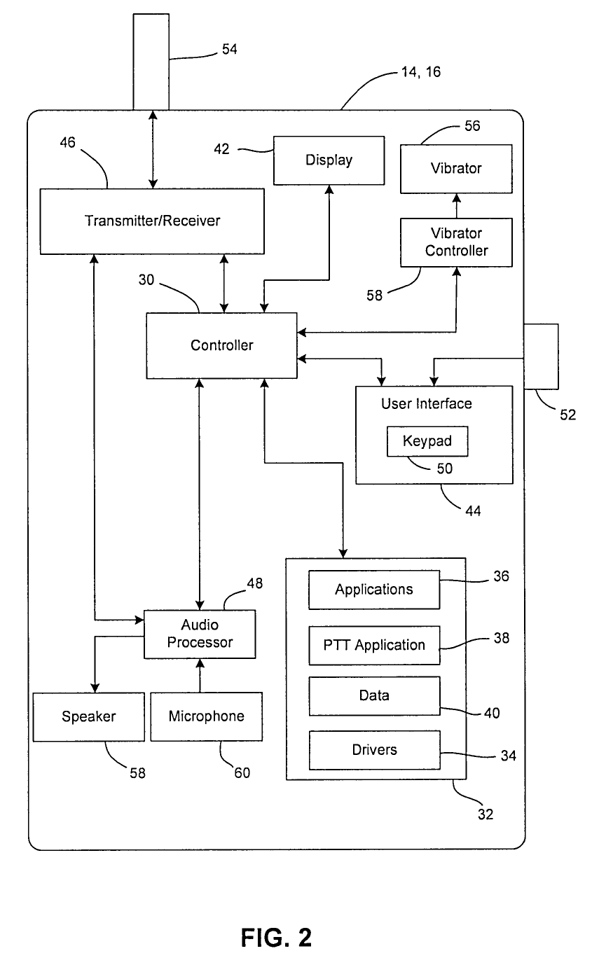

FIG. 2 represents a functional block diagram of a portable communication device 14, 16 in accordance with aspects of the present invention. The portable communication device 14, 16 includes a controller 30 for controlling the overall operation of the portable communication device. The controller 30 may be any commercially available or custom microprocessor. Memory 32 is operatively connected to the controller 30 for storing control programs and data used by the portable communication device. The memory 32 is representative of the overall hierarchy of memory devices containing software and data used to implement the functionality of the portable communication device in accordance with aspects of the present invention.

In the illustrated embodiment, memory 32 stores device drivers 34, e.g., I/O device drivers, application programs, indicated generally by reference numeral 36 generally, including a push-to-talk (PTT) application program 38 (also referred to as a PTT processor) that supports the silent PTT call pacing functionality described more fully herein, and application program data 40. The I/O device drivers include software routines that are accessed through the processor 30 (or by an operating system (not shown) stored in memory 32) by the application programs 36, including the PTT application program 38, to communicate with devices such as the display 42 and other input/output ports.

The application programs 36, including the PTT application program 38, comprise programs that implement various features of the portable communication device 14, 16, such as e-mail, Internet access, contact manager and the like. As is discussed more fully below, the PTT application program 38 comprises a program that facilitates PTT communications, including silent call pacing to indicate a number of call states or call state prompts that occur while engaging in PTT communications.

A person having ordinary skill in the art of computer programming, and specifically in applications programming for mobile phones, will consider it obvious in view of the description provided herein how to program a mobile phone to operate and carry out the functions described herein with respect to the PTT application program 38 (and any interfacing between the PTT application program 38 and other application programs 36 present on the mobile phone). Accordingly, details as to specific programming code have been left out for the sake of brevity. Also, while the PTT communications functionality, including silent PTT call pacing, is carried out via the processor and PTT application program 38 (alone or in conjunction with other application programs and control modules) in memory 32 in accordance with aspects of the invention, such function could also be carried out via dedicated hardware, firmware, software or combinations thereof without departing from the scope of the present invention.

With continued reference to FIG. 2, the controller 30 interfaces with the display 42, a user interface unit 44, a transmitter/receiver 46 (often referred to as a transceiver) and audio processing circuits, such as an audio processor 48, e.g., an audio processing circuit. In the illustrated embodiment, the user interface unit 44 includes or is operatively coupled to a keypad 50 and a PTT actuator 52, e.g., a button used to initiate PTT functions, such as initiating a PTT communication session, taking control of the floor and the like, during a typical PTT communication session. While the PTT actuator 52 is depicted as a separate and dedicated user interface button, it will be appreciated that other existing buttons or keys on the mobile phone, e.g., one or more of the keys within the keypad 50 (so-called “soft keys), may be employed to provide the PTT functionality. In other words, the present invention is not intended to be limited to any particular configuration or geometry of PTT actuators.

The display 42, keypad 50 and the PTT actuator 52 provide are part of a user interface unit 44 that allows the user to interact with the mobile phone 14, 16. For example, keypad 50 allows the user to dial numbers, enter commands and data, and select options. The display 42 allows the user to view a variety of information, such as dialed digits, stored information, and output from various applications, including the PTT application program 38. As is discussed more fully below, the PTT actuator 52 allows a user to initiate a PTT session, e.g., inviting one or more other users to participate in a PTT communications session, and/or take control of the floor for speaking during the PTT communications session, in response to or otherwise based on silent call pacing signals provided by the mobile phone.

An antenna 54 is coupled to the transmitter/receiver 46 such that the transmitter/receiver 46 transmits and receives signals via the antenna 54, as is conventional. The portable communication device 14, 16 includes an audio processor 48 for processing the audio signal transmitted by and received from the transmitter/receiver 46. Coupled to the audio processor 48 are a speaker 58 and microphone 60, which enable a user to listen and speak via the portable communication device.

The portable communication device 14, 16 includes a tactile alert generator 56, e.g., vibrator 56 depicted in FIG. 2, (also referred to as a tactile call pace generator) operatively coupled to a controller 58 for the tactile alert generator 56. The tactile alert generator 56 may include any device or mechanism operable to provide tactile feedback, e.g., a vibration sensation or movement sensation for the mobile device, in response to a driving signal from the controller 58. The tactile alert generator may include an axially offset counterweight driven by a motor, a piezoelectric device, a solenoid device, a MEMS device or the like. The controller 58 may include any suitable motor controller or driver, such as an integrated circuit motor driver. An example of a suitable driver is MAX1749 available from Maxim Integrated Products. The present invention is not intended to be limited to a particular tactile alert generator or to a particular controller for a particular tactile alert generator. As will be described more fully below, the PTT application program generates command signals for the controller, e.g., turning the tactile alert generator on and off, pulsing the tactile alert generator and the like, to provide appropriate control or driving of the tactile alert generator to accomplish silent PTT call pacing in a manner consistent with that described more fully below.

The present disclosure refers to or otherwise uses the terms “silent call pacing”, “silent PTT call pacing” or the like. Artisans will appreciate that these terms are meant to include the relatively quiet sound associated with providing a tactile call pacing alert or signal, such as a signal or alert provided by a vibrator or other tactile alert generator. In one embodiment, the terms “silent call pacing”, “silent PTT call pacing” or the like are meant to include any call pacing that does not include the conventional (and often loud) “DOOO-DEEP” audio signal that has been used in the past to indicate various PTT call states. In addition, while aspects of the invention are being described with respect silent PTT call pacing using tactile alerts, e.g., vibration bursts, other “silent” alerts, i.e., alerts other than the conventional “DOOO-DEEP” audio signals used for PTT call pacing, may be employed, such as visual alerts, e.g., blinking lights and the like.

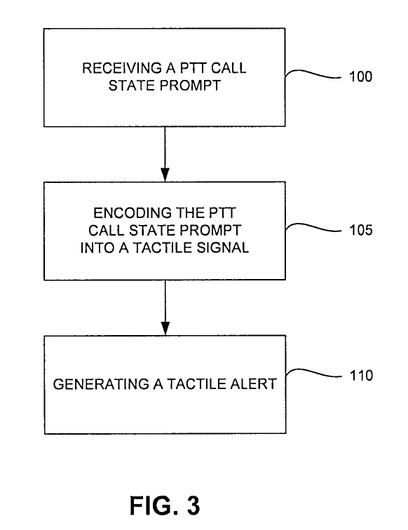

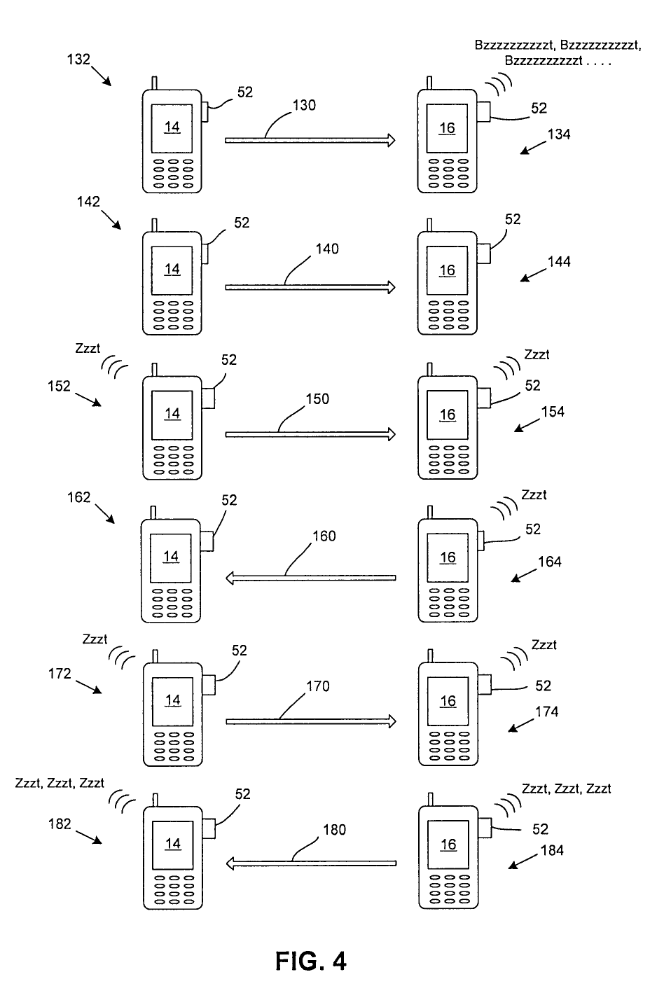

While for purposes of simplicity of explanation, the flow charts or diagrams in FIG. 3 and FIG. 4 include a series of steps or functional blocks that represent one or more aspects of the relevant operation of the portable communication device 14, 16, it is to be understood and appreciated that aspects of the present invention are not limited to the order of steps or functional blocks, as some steps or functional blocks may, in accordance with aspects of the present invention, occur in different orders and/or concurrently with other steps or functional blocks from that shown and described herein. Moreover, not all illustrated steps or functional blocks of aspects of relevant operation may be required to implement a methodology in accordance with an aspect of the invention. Furthermore, additional steps or functional blocks of aspects of relevant operation may be added without departing from the scope of the present invention.

Aspects of the present invention are being described with respect to a PTT communication session. Artisans will appreciate that, in general, the signal flow associated with a PTT communication session includes one user attempting to activate or otherwise initiate a PTT communication session by transmitting an activation request, e.g., by pressing the appropriate actuator or PTT call button. An appropriate server, e.g., a PTT communication server verifies that a PTT communication channel is available, and then assigns a channel to the requesting mobile phone. Any message provided by the user of the requesting mobile phone is received by the PTT communication server and relayed to each receiving or invited mobile phone. Once a PTT communication session is established between at least two mobile phones, only one party at a time may speak or otherwise transmit data. Typically, this is accomplished by the user pressing and holding the PTT actuator on the mobile phone (also referred to as taking control of the floor). Typically, floor control is granted or otherwise established by the controlling PTT communication server. A user may continue to speak while the user has control of the floor. When the user is finished speaking, the user may release the PTT actuator, thereby relinquishing control of the floor so that another participant in the PTT communication session may speak after taking control of the floor.

Turning now to FIG. 3, a method of pacing a call or communication session, e.g., a push-to-talk (PTT) call or communication session begins at functional block 100 where a portable communication device receives a PTT call state prompt. Artisans will appreciate that a number of PTT call state prompts may be received, including, but not limited to an incoming conversation request, an indication that a PTT communication floor is open, granting of control of the PTT communication floor, denial of control of the PTT communication floor, arrival or departure of a user to PTT communication session, termination of the PTT communication session, and the like. Of course, other call state prompts may be received without departing from the scope of the present invention. In addition, while aspects of the invention are being described with respect to silent call pacing of a PTT communication session, it will be appreciated that aspects of the invention also are applicable to silent or tactile call pacing in other communication sessions where users expect call pacing alerts or signals.

At functional block 105, the received PTT call state prompt is encoded into a tactile signal (or other silent call pacing signal). In one embodiment, encoding the received PTT call state includes providing or otherwise retrieving a tactile signal indicative of the received call state prompt. This may include providing a distinguishable or otherwise discernable tactile alert or signal for each received PTT call state prompt. For example, each PTT call state prompt may be encoded into a distinguishable or otherwise discernable vibration burst or vibration bursts. Encoding may include producing a set of tactile alerts comprised of vibration bursts that are distinguishable by (i) vibration intensity, (ii) vibration duration, and/or (iii) vibration duty cycle. Such vibration bursts may include, for example, one, two or three vibration bursts in groups. As used herein, the term “vibration burst” includes one or more bursts of vibration generated or otherwise provided by the tactile alert generator 56, e.g., by pulsing the tactile alert generator such that, in the embodiment in which the tactile alert generator is a vibrator made up of an axially offset counterweight driven by a motor, a small number of motor revolutions is generated. For example, the vibrator may be pulsed to generate one or two motor revolutions, two or three motor revolutions, four or five motor revolutions, or some other relatively small number of motor revolutions. For purposes of the discussion contained herein, a vibration burst will be understood to include a small number of motor revolutions. As such, encoding the PTT call state prompt can include generating one, two, three or more vibration bursts depending on which PTT call state prompt is received.

As discussed above, typical examples of PTT call state prompts include, but are not limited to, an indication of an incoming conversation request, an indication that the PTT floor is open, an indication that the user has control of the floor and is free to speak, an indication that an attempt to obtain control of the floor was denied because another user obtained control of the floor first, that the call has ended due to all other users exiting the PTT communication session, that one or more users has entered or exited the conversation, and the like. It will be appreciated that the present invention is not limited to a particular encoding of various call state prompts. For example, it is not intended that the invention be limited to, for example, a single vibration burst to indicate that the floor is open or that the user obtained control of the floor, or that a double vibration burst indicates that a user has failed to obtain control of the floor. In other words, the vibration bursts patterns described below represent exemplary vibration burst patterns for encoding the various PTT call state prompts.

In one embodiment, encoding the various received call state prompts into tactile alerts or signals, e.g., one or more vibration bursts, includes the replacing of or otherwise suppressing audio tones, e.g., the “DOOO-DEEP” audio tones, with appropriate tactile alerts. Where the conventional audio tones are generated internally within the phone, producing a corresponding vibration signal simply requires commanding the phone to suppress the conventional audio tone and to replace the conventional audio tone with the appropriate tactile alert. However, in some cases, the appropriate application server, e.g., the PTT communication server, generates audio signaling tones, which may be transmitted over the voice channel. To generate appropriate tactile alerts in this case, the mobile phone may provide encoding in one or more manners, including, but not limited to, relying on network messaging/signaling to suppress tones and generating the desired tactile alert, relying on timing to suppress the conventional audio tones, e.g., if a server tone always arrives before a user starts speaking, etc., then, for example, the initial 100 milliseconds (or a longer or shorter time interval) could be silenced or suppressed, or relying on context to provide the tactile alert signaling and suppression of all audio tones. Artisans will appreciate that other methodologies may be employed for silencing or otherwise suppressing server-produced audio tones, if necessary.

At step 110, a tactile alert, e.g., one or more vibration bursts are generated to indicate to the user which PTT call state prompt has been received by their mobile phone, and what action may be required by the user.

Referring now to FIG. 4, an exemplary signal flow diagram representing a PTT conversation or communication session between two users or mobile phones is depicted. The exemplary embodiment illustrated in FIG. 4 includes a PTT conversation between a user via mobile phone 14 and a second user via mobile phone 16. Throughout the description of this exemplary embodiment, reference will be made to the PTT actuator 52, e.g., a dedicated PTT button located on the right side of the mobile phone, being either depressed, e.g., as shown in event 132, or being released, e.g., as shown in event 134. It will be appreciated that while FIG. 4 includes or otherwise describes a given set of tactile alerts, e.g., vibration bursts, for each PTT call state prompt, that the invention is not intended to be limited to the exact series or set of vibration bursts described with reference to FIG. 4. Rather, any suitable set of tactile alerts or silent PTT call pacing alerts may be employed without departing from the scope of the present invention. Further, it will be appreciated that various events depicted in and described with reference to FIG. 4 may occur more or less at the same time. That is, aspects of the present invention are not limited to the order of steps or the order of the occurrence of events depicted in FIG. 4, as some steps or events may, in accordance with aspects of the present invention, occur in different orders and/or concurrently with other steps or events from that shown and described herein.

At step 130, mobile phone 14 initiates a PTT call or communication session with mobile phone 16 by, for example, selecting the user of mobile phone 16 from a contact list and requesting a conversation by depressing PTT actuator 52 (event 132). The user of mobile phone 16 senses an incoming call by what could be referred to or thought of as a normal incoming call vibrate alert, e.g., a vibration alert as would be received for normal voice calls (event 134). A typical vibration alert for normal voice calls may include three extended vibrations, each of which is represented in FIG. 4 as “Bzzzzzzzzzzt”. At step 140, mobile phone 14 automatically has control of the floor with PTT actuator 52 depressed (event 142) (assuming that the call is established and floor control is granted by the PTT communication server) and mobile phone 16 accepts the incoming conversation and hears the user of mobile phone 14 speaking (event 144).

At step 150, the user of mobile phone 14 releases the PTT actuator 52 when he/she is finished speaking (event 152). At this time, the users of both mobile phones 14 and 16 receive a predetermined vibration burst, e.g., a single short vibration burst that is represented as “Zzzt” in FIG. 4. As described above, the mobile phone can be controlled by the PTT application program 38 and vibrator controller 58 to pulse the vibrator 56 (FIG. 2) to provide a short vibration burst, e.g., provided by anywhere from about one to about five motor revolutions of the vibrator.

At step 160, the user of mobile phone 16 may depress the PTT actuator (event 164) in an attempt to gain control of the floor. In response to this attempt to obtain control of the floor, the user of mobile phone 16 may receive either a single short vibration burst (depicted as Zzzt), which is indicative of being granted control of the floor or two short vibration bursts (depicted as Zzzt Zzzt), which is indicative of another user obtaining control of the floor before the user of mobile phone 16. At this stage of the conversation, if the user of mobile phone 16 obtained control of the floor, he/she can speak to the user of mobile phone 14 who can hear the user of mobile phone 16 speaking (event 162).

At step 170, the user of mobile phone 16 may release the PTT actuator when he/she is finished talking (event 174). At this point, the users of mobile phone 14 and 16 could each receive a tactile alert, e.g., a single vibration burst (Zzzt) indicating that the floor is open. At step 180, if either party terminates the call, the users of both mobile phones 14 and 16 will receive a tactile alert, e.g., three short vibration bursts (depicted in FIG. 4 as Zzzt. Zzzt. Zzzt), indicating that the PTT communication session has been terminated or otherwise ended.

While aspects of the present invention have been described with silent PTT call pacing, it will be appreciated that aspects of the present invention may be applicable to pace any call or interaction using a mobile phone when a given signal or indicator is expected by the user of the mobile phone. In addition, while aspects of the present invention have been described with respect to encoding various PTT call states using one or more short vibration bursts, e.g., produced by pulsing the motor of the tactile alert generator, it will be appreciated that other methods of encoding PTT call states may be employed, including, but not limited to varying the intensity of vibration, the duration of vibration, the duty cycle as well as the number of vibration bursts.

As will be appreciated by one of skill in the art, computer program elements and/or circuitry elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A method of pacing a push-to-talk (PTT) communication session, the method comprising:
receiving a PTT call state prompt;
encoding the received PTT call state prompt into a tactile signal;
generating a tactile alert indicative of the received PTT call state prompt.

2. The method according to claim 1, wherein the tactile alert includes one or more vibration bursts.

3. The method according to claim 1, wherein generating one or more vibration bursts includes pulsing a vibration motor to cause no more than about one to about three revolutions of the vibration motor.

4. The method according to claim 1, wherein encoding includes producing a set of tactile alerts comprised of vibration bursts that are distinguishable by (i) vibration intensity, (ii) vibration duration, and/or (iii) vibration duty cycle.

5. The method according to claim 1, wherein encoding includes suppressing an audio signal associated with a PTT call state prompt, and replacing the suppressed audio signal with one or more vibration bursts.

6. The method according to claim 5, wherein each distinguishable tactile alert is indicative of one or more PTT call state prompts.

7. The method according to claim 6, wherein the PTT call state prompts include (i) incoming conversation request, (ii) indication that a PTT communication floor is open, (iii) granting of control of the PTT communication floor, (iv) denial of control of the PTT communication floor, (v) arrival or departure of a user to PTT communication session, and/or (vi) termination of the PTT communication session.

8. A portable communication device comprising:
a tactile alert generator that generates tactile alerts;
a controller for the tactile alert generator; and
a push-to-talk (PTT) processor in operative communication with the controller for the tactile alert generator, wherein the PTT processor:
encodes a received PTT call state prompt into a tactile signal; and
generates a tactile signal that causes the tactile alert generator to generate a tactile alert indicative of the received PTT call state prompt.

9. The portable communication device according to claim 8, wherein the tactile alerts include one or more vibration bursts.

10. The portable communication device according to claim 9, wherein the PTT call state prompts include (i) incoming conversation request, (ii) indication that a PTT communication floor is open, (iii) granting of control of the PTT communication floor, (iv) denial of control of the PTT communication floor, (v) arrival or departure of a user to PTT communication session, and/or (vi) termination of the PTT communication session.

11. The portable communication device according to claim 8, wherein the tactile alert generator comprises a vibrator.

12. The portable communication device according to claim 11, wherein the vibrator comprises an axially offset counterweight driven by a motor.

13. The portable communication device according to claim 12, wherein the vibrator produces one or more vibration bursts.

14. The portable communication device according to claim 13, wherein a vibration burst is produced by about one to about three motor revolutions of the counterweight.

15. The portable communication device according to claim 13, wherein a vibration burst is produced by no more than about five motor revolutions of the counterweight.

16. The portable communication device according to claim 8, wherein the vibrator comprises a piezoelectric vibration device.

17. The portable communication device according to claim 8, wherein the portable communication device is a mobile telephone.

18. A program stored on a machine readable medium, the program being suitable for use in a portable communication device, wherein when the program is loaded in memory in the portable communication device and executed causes the portable communication device to:
encode a received PTT call state prompt into a tactile signal; and
generate a tactile signal that causes a tactile alert generator to generate a tactile alert indicative of the received PTT call state prompt.

19. The program according to claim 18, wherein the program causes the tactile alert generator to generator one or more vibration bursts indicative of the received PTT call state prompt.

20. A portable communication device comprising a memory and a processor that executes the application program according to claim 18.
